(19) United States
(12) Patent Application Publication
(10) Pub. No.: US 2017/0039639 A1
(43) Pub. Date: Feb. 9, 2017

(54) EXPLICIT ALLOCATION TOOL

(71) Applicant: TRADING TECHNOLOGIES INTERNATIONAL INC., Chicago, IL (US)

(72) Inventor: Scott F. SINGER, Green Oaks, IL (US)

(21) Appl. No.: 14/816,641

(22) Filed: Aug. 3, 2015

(51) Int. Cl. G06Q 40/04

(52) U.S. Cl. CPC G06Q 40/04

(57) ABSTRACT

Trade orders received from trading devices may be matched according to an order state associated with each trade order. Trade orders may be submitted at trading devices and may indicate an order state. The order state may be a passive order state or an aggressive order state. Trade orders in an aggressive order state may be matched with other trade orders. Trade orders submitted in a passive order state may rest in the market until orders with an aggressive order state are available to match at a complementary price. As passive orders may encourage additional orders to be submitted and executed at an exchange, trade orders that are submitted in the passive order state may be encouraged by providing a trade incentive to a trading device or a user of a trading device that submits a trade order in a passive order state.

### BACKGROUND

An electronic trading system generally includes a trading device in communication with an electronic exchange. The trading device receives information about a market, such as prices and quantities, from the electronic exchange. The electronic exchange receives messages, such as messages related to orders, from the trading device. The electronic exchange attempts to match quantity of an order with quantity of one or more contra-side orders.

Match or matching engines utilized at the electronic exchange generally implement a set of rules to match orders received from trading devices. Many trading engines at electronic exchanges match orders in a trading queue based on a first-in, first-out (FIFO) or a last-in, first-out (LIFO) system. Matching orders using such systems may cause trades to be executed with little user control over an executed trade once the user submits an order. Matching orders using such systems may also prevent trades from being executed, as users may be reluctant to submit an order for fear of giving up edge.

### BRIEF DESCRIPTION OF THE FIGURES

Certain embodiments are disclosed with reference to the following drawings.

FIG. 1 illustrates a block diagram representative of an example electronic trading system in which certain embodiments may be employed.

FIG. 2 illustrates a block diagram of another example electronic trading system in which certain embodiments may be employed.

FIG. 3 illustrates a block diagram of an example computing device which may be used to implement the disclosed embodiments.

FIG. 4 illustrates a block diagram of an example electronic trading system for executing a trade.

FIGS. 5A-5B illustrate diagrams of example trading interfaces for placing orders.

FIG. 6 illustrates a diagram of an example market window.

FIG. 7 illustrates an example flow diagram for executing a trade.

FIG. 8 illustrates an example flow diagram for providing a trade incentive.

Certain embodiments will be better understood when read in conjunction with the provided figures, which illustrate examples. It should be understood, however, that the embodiments are not limited to the arrangements and instrumentality shown in the attached figures.

### DETAILED DESCRIPTION

This disclosure relates to matching orders received from trading devices. Order messages may be received at a matching engine that indicates an order state associated with a trade order. The order state may be identified as a passive order state or an aggressive order state. An aggressive order state indicates an order that is immediately available to be executed (i.e., matched). A passive order state indicates an order that is available to be executed, or matched, against an aggressive order. The matching engine may execute a trade between orders that have complementary order states. For example, a trade may be executed between trade orders that each have an aggressive order state. Aggressive orders may also, for example, be executed against passive orders, while passive orders will not be executed against other passive orders.

As passive orders may encourage additional orders to be submitted and executed at an exchange, trade orders that are submitted in the passive order state may be encouraged by providing a trade incentive to a trading device or a user of a trading device that submits a trade order in a passive order state. The trade incentive may include a credit that may be applied to a trading account of the user. The credit may be used in a future trade, for example to pay the commission of a future trade. The trade incentive may vary based on the order price and/or the order quantity. For example, a higher trade incentive may be provided when the order price for a buy order is above a current market price. A higher trade incentive may be provided when the order price for a sell order is below a current market price.

Although this description discloses embodiments including, among other components, software executed on hardware, it should be noted that the embodiments are merely illustrative and should not be considered as limiting. For example, it is contemplated that any or all of these hardware and software components may be embodied exclusively in hardware, exclusively in software, exclusively in firmware, or in any combination of hardware, software, and/or firmware. Accordingly, certain embodiments may be implemented in other ways.

### I. Brief Description of Certain Embodiments

Embodiments are described herein for enabling execution of a trade between trade orders received from trading devices when the order states associated with the trade orders are complementary.

Systems, methods, and apparatus are described herein for receiving, from a first computing device, a first order related to a tradeable object. The first order may indicate an order price and a first order state. A second order may be received from a second computing device. The second order may be related to the tradeable object and may indicate the order price and a second order state. A computing device may determine whether the second order state complements the first order state in a combination of states that enables execution of a trade of the tradeable object. When the second order state complements the first order state, the trade between the first order and the second order may be executed at the order price.

The second order state may complement the first order state when the second order state matches the first order state. The first order state may comprise a passive order state that prevents the first order from being executed in the trade for at least a predetermined period of time. The second order state may complement the first order state when the predetermined period of time has elapsed and the second order state comprises an aggressive order state indicating an instruction to use the second order to execute the trade.

A trade incentive may be determined for the first order indicating a passive order state. A trading account associated with the computing device that submitted the first order may be credited when the trade is executed between the first order and the second order. A second trade incentive may be determined for the second order state indicating the passive order state. A second trading account associated with the computing device that submitted the second order may be credited when the trade is executed between the first order and the second order. The first trade incentive may be greater than the second trade incentive.

An indication of the first order may be sent to the second computing device and the indication may indicate, to the second computing device, that the first order is associated with the first order state. An indication of the second order may be sent to the first computing device and the indication may indicate, to the first computing device, that the second order is associated with the second order state that complements the first order state. An instruction may be received from the first computing device to execute the trade between the first order and the second order. A communication may be sent to the first computing device and the second computing device that the trade between the first order and the second order has been executed.

A matching engine located at an electronic exchange and/or a trading device may implement the embodiments described herein.

The first order and the second order may be received via a communication interface located at a third computing device. A processor located at the third computing device may determine whether the second order state complements the first order state. The third computing device may be one of a trading device or an electronic exchange.

The first computing device and the second computing device may be trading terminals.

Systems, methods, and apparatus are described herein for defining, tracking and implementing a mechanism that provides a trade incentive. The trade incentive may be associated with a passive order state configured to control execution of an order. A first order related to a tradeable object may be received from a first computing device. The first order may indicate an order price, an order quantity, and a first order state comprising the passive order state. The trade incentive may be provided to a user of the first computing device. The first order may be displayed in a trading window at a price level that is based on the order price. An indication that the first order is in the passive order state may also be displayed. A second order related to the tradeable object may be received from a second computing device. The second order may indicate the order price, at least a portion of the order quantity, and a second order state comprising an aggressive order state. The aggressive order state may enable the second order to be executed in the trade with the first order when the first order state comprises the aggressive order state. The second order may be displayed in the trading window at the price level that is based on the order price. An indication that the second order is in the aggressive order state may be displayed. An instruction may be received from the first computing device to change the first order state to the aggressive order state.

The trade between the first order and the second order may be executed based on the first order state and the second order state comprising the aggressive order state. A message may be sent to the first computing device and the second computing device that indicates the trade executed between the first order and the second order.

### II. Example Electronic Trading System

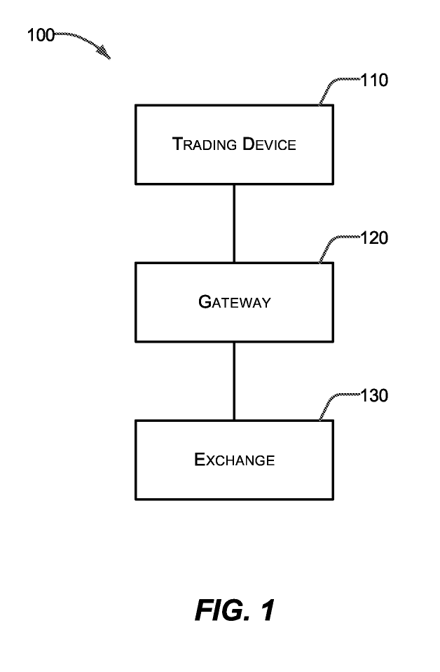

FIG. 1 illustrates a block diagram representative of an example electronic trading system 100 in which certain embodiments may be employed. The system 100 includes a trading device 110, a gateway 120, and an exchange 130. The trading device 110 is in communication with the gateway 120. The gateway 120 is in communication with the exchange 130. As used herein, the phrase “in communication with” encompasses direct communication and/or indirect communication through one or more intermediary components. The exemplary electronic trading system 100 depicted in FIG. 1 may be in communication with additional components, subsystems, and elements to provide additional functionality and capabilities without departing from the teaching and disclosure provided herein.

In operation, the trading device 110 may receive market data from the exchange 130 through the gateway 120. A user may utilize the trading device 110 to monitor this market data and/or base a decision to send an order message to buy or sell one or more tradeable objects to the exchange 130.

Market data may include data about a market for a tradeable object. For example, market data may include the inside market, market depth, last traded price (“LTP”), a last traded quantity (“LTQ”), or a combination thereof. The inside market refers to the highest available bid price (best bid) and the lowest available ask price (best ask or best offer) in the market for the tradeable object at a particular point in time (since the inside market may vary over time). Market depth refers to quantities available at price levels including the inside market and away from the inside market. Market depth may have “gaps” due to prices with no quantity based on orders in the market.

The price levels associated with the inside market and market depth can be provided as value levels which can encompass prices as well as derived and/or calculated representations of value. For example, value levels may be displayed as net change from an opening price. As another example, value levels may be provided as a value calculated from prices in two other markets. In another example, value levels may include consolidated price levels.

A tradeable object is anything which may be traded. For example, a certain quantity of the tradeable object may be bought or sold for a particular price. A tradeable object may include, for example, financial products, stocks, options, bonds, future contracts, currency, warrants, funds derivatives, securities, commodities, swaps, interest rate products, index-based products, traded events, goods, or a combination thereof. A tradeable object may include a product listed and/or administered by an exchange, a product defined by the user, a combination of real or synthetic products, or a combination thereof. There may be a synthetic tradeable object that corresponds and/or is similar to a real tradeable object.

An order message is a message that includes a trade order. A trade order may be, for example, a command to place an order to buy or sell a tradeable object; a command to initiate managing orders according to a defined trading strategy; a command to change, modify, or cancel an order; an instruction to an electronic exchange relating to an order; or a combination thereof.

The trading device 110 may include one or more electronic computing platforms. For example, the trading device 110 may include a desktop computer, hand-held device, laptop, server, a portable computing device, a trading terminal, an embedded trading system, a workstation, an algorithmic trading system such as a “black box” or “grey box” system, cluster of computers, or a combination thereof. As another example, the trading device 110 may include a single or multi-core processor in communication with a memory or other storage medium configured to accessibly store one or more computer programs, applications, libraries, computer readable instructions, and the like, for execution by the processor.

As used herein, the phrases “configured to” and “adapted to” encompass that an element, structure, or device has been modified, arranged, changed, or varied to perform a specific function or for a specific purpose.

By way of example, the trading device 110 may be implemented as a personal computer running a copy of X_TRADER®, an electronic trading platform provided by Trading Technologies International, Inc. of Chicago, Ill. (“Trading Technologies”). As another example, the trading device 110 may be a server running a trading application providing automated trading tools such as ADL®, AUTOSPREADER®, and/or AUTOTRADER™, also provided by Trading Technologies. In yet another example, the trading device 110 may include a trading terminal in communication with a server, where collectively the trading terminal and the server are the trading device 110.

The trading device 110 is generally owned, operated, controlled, programmed, configured, or otherwise used by a user. As used herein, the phrase “user” may include, but is not limited to, a human (for example, a trader), trading group (for example, a group of traders), or an electronic trading device (for example, an algorithmic trading system). One or more users may be involved in the ownership, operation, control, programming, configuration, or other use, for example.

The trading device 110 may include one or more trading applications. As used herein, a trading application is an application that facilitates or improves electronic trading. A trading application provides one or more electronic trading tools. For example, a trading application stored by a trading device may be executed to arrange and display market data in one or more trading windows. In another example, a trading application may include an automated spread trading application providing spread trading tools. In yet another example, a trading application may include an algorithmic trading application that automatically processes an algorithm and performs certain actions, such as placing an order, modifying an existing order, deleting an order. In yet another example, a trading application may provide one or more trading screens. A trading screen may provide one or more trading tools that allow interaction with one or more markets. For example, a trading tool may allow a user to obtain and view market data, set order entry parameters, submit order messages to an exchange, deploy trading algorithms, and/or monitor positions while implementing various trading strategies. The electronic trading tools provided by the trading application may always be available or may be available only in certain configurations or operating modes of the trading application.

A trading application may be implemented utilizing computer readable instructions that are stored in a computer readable medium and executable by a processor. A computer readable medium may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable storage media and to exclude propagating signals.

One or more components or modules of a trading application may be loaded into the computer readable medium of the trading device 110 from another computer readable medium. For example, the trading application (or updates to the trading application) may be stored by a manufacturer, developer, or publisher on one or more CDs or DVDs, which are then loaded onto the trading device 110 or to a server from which the trading device 110 retrieves the trading application. As another example, the trading device 110 may receive the trading application (or updates to the trading application) from a server, for example, via the Internet or an internal network. The trading device 110 may receive the trading application or updates when requested by the trading device 110 (for example, “pull distribution”) and/or un-requested by the trading device 110 (for example, “push distribution”).

The trading device 110 may be adapted to send order messages. For example, the order messages may be sent to through the gateway 120 to the exchange 130. As another example, the trading device 110 may be adapted to send order messages to a simulated exchange in a simulation environment which does not effectuate real-world trades.

The order messages may be sent at the request of a user. For example, a trader may utilize the trading device 110 to send an order message or manually input one or more parameters for a trade order (for example, an order price and/or quantity). As another example, an automated trading tool provided by a trading application may calculate one or more parameters for a trade order and automatically send the order message. In some instances, an automated trading tool may prepare the order message to be sent but not actually send it without confirmation from a user.

An order message may be sent in one or more data packets or through a shared memory system. For example, an order message may be sent from the trading device 110 to the exchange 130 through the gateway 120. The trading device 110 may communicate with the gateway 120 using a local area network, a wide area network, a wireless network, a virtual private network, a cellular network, a peer-to-peer network, a T1 line, a T3 line, an integrated services digital network (“ISDN”) line, a point-of-presence, the Internet, a shared memory system and/or a proprietary network such as TTNET™ provided by Trading Technologies, for example.

The gateway 120 may include one or more electronic computing platforms. For example, the gateway 120 may be implemented as one or more desktop computer, hand-held device, laptop, server, a portable computing device, a trading terminal, an embedded trading system, workstation with a single or multi-core processor, an algorithmic trading system such as a “black box” or “grey box” system, cluster of computers, or any combination thereof.

The gateway 120 may facilitate communication. For example, the gateway 120 may perform protocol translation for data communicated between the trading device 110 and the exchange 130. The gateway 120 may process an order message received from the trading device 110 into a data format understood by the exchange 130, for example. Similarly, the gateway 120 may transform market data in an exchange-specific format received from the exchange 130 into a format understood by the trading device 110, for example.

The gateway 120 may include a trading application, similar to the trading applications discussed above, that facilitates or improves electronic trading. For example, the gateway 120 may include a trading application that tracks orders from the trading device 110 and updates the status of the order based on fill confirmations received from the exchange 130. As another example, the gateway 120 may include a trading application that coalesces market data from the exchange 130 and provides it to the trading device 110. In yet another example, the gateway 120 may include a trading application that provides risk processing, calculates implieds, handles order processing, handles market data processing, or a combination thereof.

In certain embodiments, the gateway 120 communicates with the exchange 130 using a local area network, a wide area network, a wireless network, a virtual private network, a cellular network, a peer-to-peer network, a T1 line, a T3 line, an ISDN line, a point-of-presence, the Internet, a shared memory system, and/or a proprietary network such as TTNET™ provided by Trading Technologies, for example.

The exchange 130 may be owned, operated, controlled, or used by an exchange entity. Example exchange entities include the CME Group, the London International Financial Futures and Options Exchange, the Intercontinental Exchange, and Eurex. The exchange 130 may include an electronic matching system, such as a computer, server, or other computing device, which is adapted to allow tradeable objects, for example, offered for trading by the exchange, to be bought and sold. The exchange 130 may include separate entities, some of which list and/or administer tradeable objects and others which receive and match orders, for example. The exchange 130 may include an electronic communication network (“ECN”), for example.

The exchange 130 may be an electronic exchange. The exchange 130 is adapted to receive order messages and match contra-side trade orders to buy and sell tradeable objects. Unmatched trade orders may be listed for trading by the exchange 130. Once an order to buy or sell a tradeable object is received and confirmed by the exchange, the order is considered to be a working order until it is filled or cancelled. If only a portion of the quantity of the order is matched, then the partially filled order remains a working order. The trade orders may include trade orders received from the trading device 110 or other devices in communication with the exchange 130, for example. For example, typically the exchange 130 will be in communication with a variety of other trading devices (which may be similar to trading device 110) which also provide trade orders to be matched.

The exchange 130 is adapted to provide market data. Market data may be provided in one or more messages or data packets or through a shared memory system. For example, the exchange 130 may publish a data feed to subscribing devices, such as the trading device 110 or gateway 120. The data feed may include market data.

The system 100 may include additional, different, or fewer components. For example, the system 100 may include multiple trading devices, gateways, and/or exchanges. In another example, the system 100 may include other communication devices, such as middleware, firewalls, hubs, switches, routers, servers, exchange-specific communication equipment, modems, security managers, and/or encryption/decryption devices.

### III. Expanded Example Electronic Trading System

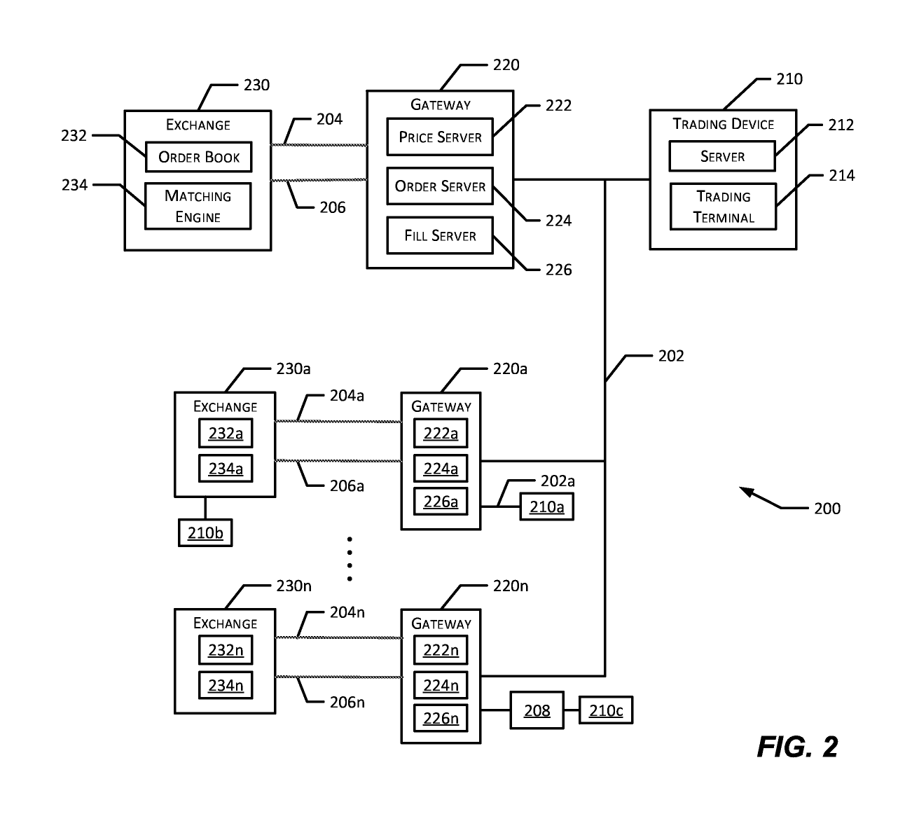

FIG. 2 illustrates a block diagram of another example electronic trading system 200 in which certain embodiments may be employed. In this example, a trading device 210 may utilize one or more communication networks to communicate with a gateway 220 and exchange 230. For example, the trading device 210 utilizes network 202 to communicate with the gateway 220, and the gateway 220, in turn, utilizes the networks 204 and 206 to communicate with the exchange 230. As used herein, a network facilitates or enables communication between computing devices such as the trading device 210, the gateway 220, and the exchange 230.

The following discussion generally focuses on the trading device 210, gateway 220, and the exchange 230. However, the trading device 210 may also be connected to and communicate with “n” additional gateways (individually identified as gateways 220a-220n, which may be similar to gateway 220) and “n” additional exchanges (individually identified as exchanges 230a-230n, which may be similar to exchange 230) by way of the network 202 (or other similar networks). Additional networks (individually identified as networks 204a-204n and 206a-206n, which may be similar to networks 204 and 206, respectively) may be utilized for communications between the additional gateways and exchanges. The communication between the trading device 210 and each of the additional exchanges 230a-230n need not be the same as the communication between the trading device 210 and exchange 230. Generally, each exchange has its own preferred techniques and/or formats for communicating with a trading device, a gateway, the user, or another exchange. It should be understood that there is not necessarily a one-to-one mapping between gateways 220a-220n and exchanges 230a-230n. For example, a particular gateway may be in communication with more than one exchange. As another example, more than one gateway may be in communication with the same exchange. Such an arrangement may, for example, allow one or more trading devices 210 to trade at more than one exchange (and/or provide redundant connections to multiple exchanges).

Additional trading devices 210a-210n, which may be similar to trading device 210, may be connected to one or more of the gateways 220a-220n and exchanges 230a-230n. For example, the trading device 210a may communicate with the exchange 230a via the gateway 220a and the networks 202a, 204a and 206a. In another example, the trading device 210b may be in direct communication with exchange 230a. In another example, trading device 210c may be in communication with the gateway 220n via an intermediate device 208 such as a proxy, remote host, or WAN router.

The trading device 210, which may be similar to the trading device 110 in FIG. 1, includes a server 212 in communication with a trading terminal 214. The server 212 may be located geographically closer to the gateway 220 than the trading terminal 214 in order to reduce latency. In operation, the trading terminal 214 may provide a trading screen to a user and communicate commands to the server 212 for further processing. For example, a trading algorithm may be deployed to the server 212 for execution based on market data. The server 212 may execute the trading algorithm without further input from the user. In another example, the server 212 may include a trading application providing automated trading tools and communicate back to the trading terminal 214. The trading device 210 may include additional, different, or fewer components.

In operation, the network 202 may be a multicast network configured to allow the trading device 210 to communicate with the gateway 220. Data on the network 202 may be logically separated by subject such as, for example, by prices, orders, or fills. As a result, the server 212 and trading terminal 214 can subscribe to and receive data such as, for example, data relating to prices, orders, or fills, depending on their individual needs.

The gateway 220, which may be similar to the gateway 120 of FIG. 1, may include a price server 222, order server 224, and fill server 226. The gateway 220 may include additional, different, or fewer components. The price server 222 may process price data. Price data includes data related to a market for one or more tradeable objects. The order server 224 processes order data. Order data is data related to a user's trade orders. For example, order data may include order messages, confirmation messages, or other types of messages. The fill server collects and provides fill data. Fill data includes data relating to one or more fills of trade orders. For example, the fill server 226 may provide a record of trade orders, which have been routed through the order server 224, that have and have not been filled. The servers 222, 224, and 226 may run on the same machine or separate machines. There may be more than one instance of the price server 222, the order server 224, and/or the fill server 226 for gateway 220. In certain embodiments, the additional gateways 220a-220n may each includes instances of the servers 222, 224, and 226 (individually identified as servers 222a-222n, 224a-224n, and 226a-226n).

The gateway 220 may communicate with the exchange 230 using one or more communication networks. For example, as shown in FIG. 2, there may be two communication networks connecting the gateway 220 and the exchange 230. The network 204 may be used to communicate market data to the price server 222. In some instances, the exchange 230 may include this data in a data feed that is published to subscribing devices. The network 206 may be used to communicate order data to the order server 224 and the fill server 226. The network 206 may also be used to communicate order data from the order server 224 to the exchange 230.

The exchange 230, which may be similar to the exchange 130 of FIG. 1, includes an order book 232 and a matching engine 234. The exchange 230 may include additional, different, or fewer components. The order book 232 is a database that includes data relating to unmatched trade orders that have been submitted to the exchange 230. For example, the order book 232 may include data relating to a market for a tradeable object, such as the inside market, market depth at various price levels, the last traded price, and the last traded quantity. The matching engine 234 may match contra-side bids and offers pending in the order book 232. For example, the matching engine 234 may execute one or more matching algorithms that match contra-side bids and offers. A sell order is contra-side to a buy order. Similarly, a buy order is contra-side to a sell order. A matching algorithm may match contra-side bids and offers at the same price, for example. In certain embodiments, the additional exchanges 230a-230n may each include order books and matching engines (individually identified as the order book 232a-232n and the matching engine 234a-234n, which may be similar to the order book 232 and the matching engine 234, respectively). Different exchanges may use different data structures and algorithms for tracking data related to orders and matching orders.

In operation, the exchange 230 may provide price data from the order book 232 to the price server 222 and order data and/or fill data from the matching engine 234 to the order server 224 and/or the fill server 226. Servers 222, 224, 226 may process and communicate this data to the trading device 210. The trading device 210, for example, using a trading application, may process this data. For example, the data may be displayed to a user. In another example, the data may be utilized in a trading algorithm to determine whether a trade order should be submitted to the exchange 230. The trading device 210 may prepare and send an order message to the exchange 230.

In certain embodiments, the gateway 220 is part of the trading device 210. For example, the components of the gateway 220 may be part of the same computing platform as the trading device 210. As another example, the functionality of the gateway 220 may be performed by components of the trading device 210. In certain embodiments, the gateway 220 is not present. Such an arrangement may occur when the trading device 210 does not need to utilize the gateway 220 to communicate with the exchange 230, such as if the trading device 210 has been adapted to communicate directly with the exchange 230.

### IV. Example Computing Device

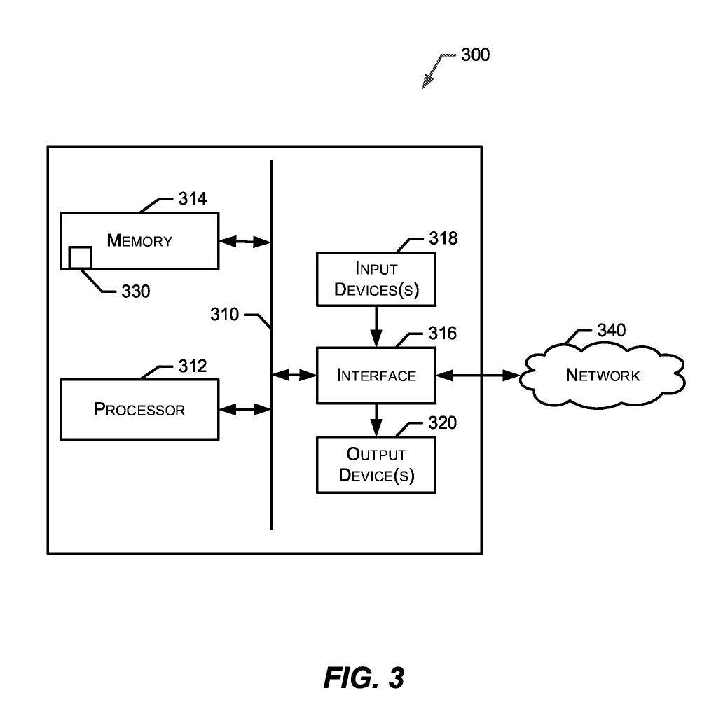

FIG. 3 illustrates a block diagram of an example computing device 300 which may be used to implement the disclosed embodiments. The trading device 110 of FIG. 1 may include one or more computing devices 300, for example. The gateway 120 of FIG. 1 may include one or more computing devices 300, for example. The exchange 130 of FIG. 1 may include one or more computing devices 300, for example.

The computing device 300 includes a communication network 310, a processor 312, a memory 314, an interface 316, an input device 318, and an output device 320. The computing device 300 may include additional, different, or fewer components. For example, multiple communication networks, multiple processors, multiple memory, multiple interfaces, multiple input devices, multiple output devices, or any combination thereof, may be provided. As another example, the computing device 300 may not include an input device 318 or output device 320.

As shown in FIG. 3, the computing device 300 may include a processor 312 coupled to a communication network 310. The communication network 310 may include a communication bus, channel, electrical or optical network, circuit, switch, fabric, or other mechanism for communicating data between components in the computing device 300. The communication network 310 may be communicatively coupled with and transfer data between any of the components of the computing device 300.

The processor 312 may be any suitable processor, processing unit, or microprocessor. The processor 312 may include one or more general processors, digital signal processors, application specific integrated circuits, field programmable gate arrays, analog circuits, digital circuits, programmed processors, and/or combinations thereof, for example. The processor 312 may be a single device or a combination of devices, such as one or more devices associated with a network or distributed processing. Any processing strategy may be used, such as multi-processing, multi-tasking, parallel processing, and/or remote processing. Processing may be local or remote and may be moved from one processor to another processor. In certain embodiments, the computing device 300 is a multi-processor system and, thus, may include one or more additional processors which are communicatively coupled to the communication network 310.

The processor 312 may be operable to execute logic and other computer readable instructions encoded in one or more tangible media, such as the memory 314. As used herein, logic encoded in one or more tangible media includes instructions which may be executable by the processor 312 or a different processor. The logic may be stored as part of software, hardware, integrated circuits, firmware, and/or micro-code, for example. The logic may be received from an external communication device via a communication network such as the network 340. The processor 312 may execute the logic to perform the functions, acts, or tasks illustrated in the figures or described herein.

The memory 314 may be one or more tangible media, such as computer readable storage media, for example. Computer readable storage media may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable medium and to exclude propagating signals. The memory 314 may include any desired type of mass storage device including hard disk drives, optical media, magnetic tape or disk, etc.

The memory 314 may include one or more memory devices. For example, the memory 314 may include local memory, a mass storage device, volatile memory, non-volatile memory, or a combination thereof. The memory 314 may be adjacent to, part of, programmed with, networked with, and/or remote from processor 312, so the data stored in the memory 314 may be retrieved and processed by the processor 312, for example. The memory 314 may store instructions which are executable by the processor 312. The instructions may be executed to perform one or more of the acts or functions described herein or shown in the figures.

The memory 314 may store a trading application 330. In certain embodiments, the trading application 330 may be accessed from or stored in different locations. The processor 312 may access the trading application 330 stored in the memory 314 and execute computer-readable instructions included in the trading application 330.

In certain embodiments, during an installation process, the trading application may be transferred from the input device 318 and/or the network 340 to the memory 314. When the computing device 300 is running or preparing to run the trading application 330, the processor 312 may retrieve the instructions from the memory 314 via the communication network 310.

### V. Executing a Trade Between Complementary Orders

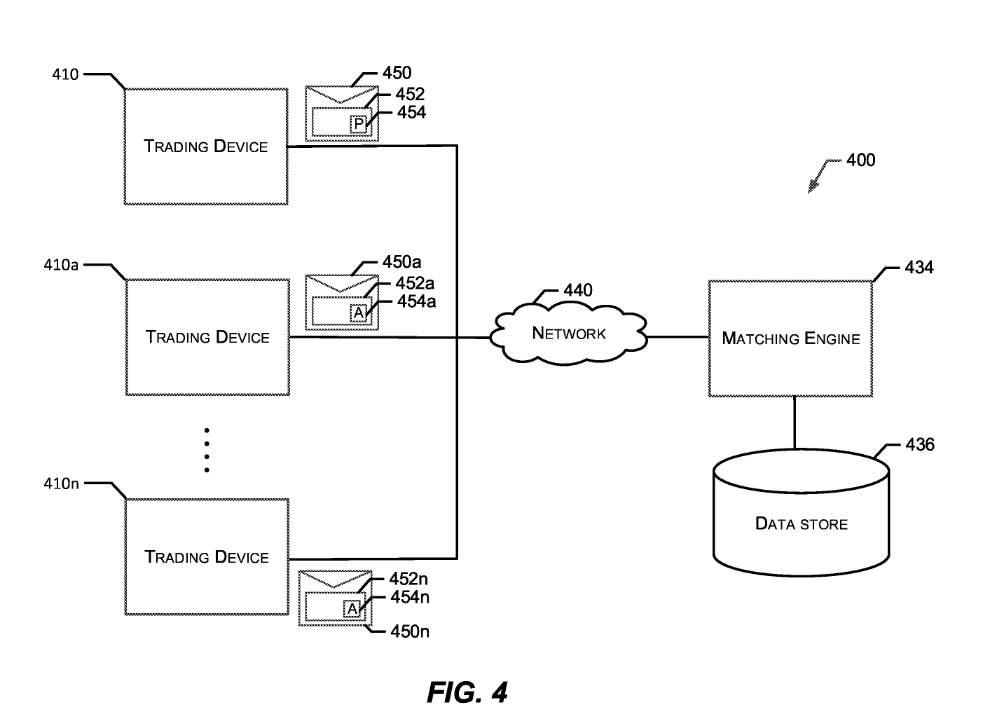

FIG. 4 illustrates a block diagram of an example electronic trading system 400 for executing a trade in accordance with the disclosure provided herein. The electronic trading system 400 may include one or more of trading devices 410 to 410n. The trading devices 410 to 410n may communicate with each other directly and/or through the network 440. The trading devices 410 to 410n may submit order messages to an exchange for executing a trade between one or more other trading devices. The trading devices 410 to 410n may communicate with a matching engine 434, or a device in which the matching engine 434 may be located, directly or through the network 440. The matching engine 434 may receive order messages 450 to 450n from trading devices 410 to 410n, respectively. The matching engine 434 may determine whether to execute a trade based on the order parameters of the trade orders in the order messages 450 to 450n. The matching engine 434 may store received trade orders and other market data in a data store 436.

The trading devices 410 to 410n may be trading terminals, such as the trading terminal 214, and/or trading servers, such as the trading server 212. The matching engine 434 may be implemented at a single device or distributed across multiple devices. For example, the matching engine 434 may be implemented locally at a trading device, a gateway, an exchange, and/or another computing device. Though not shown in FIG. 4, the matching engine 434 may be implemented locally at one of the trading devices 410 to 410n.

The trading devices 410 to 410n generate order messages 450 to 450n to be submitted to the matching engine 434. The order messages 450 to 450n may include trade orders 452 to 452a with one or more order parameters. The order parameters may include an order price and an order quantity. The order parameters of each of the order messages 450 to 450n may include an order state 454. A user of a trading device, such as trading device 410n, may submit order parameters into a trading application via an order window that may be displayed on the trading device 410. The order parameters may include an indication of an order state 454 associated with the order.

The order state 454 may be an aggressive order state or a passive order state. A trade order identified with an aggressive order state indicates that a user would like to immediately execute a trade (i.e. match) with a contra-side trade order having complimentary order parameters, such as the order price and order quantity, regardless of the order state of the contra-side trade order. A trade order identified with a passive order state indicates that the user would like to immediately execute a trade with a contra-side trade having complimentary order parameters and identified with an aggressive order state. If a contra-side trade order having complimentary order parameters and identified with an aggressive order states is not available to match, the trade order identified with a passive order states rests in the market until such time that a complimentary aggressive order becomes available. For example, a trade order identified with a passive order state may rest (e.g., not trade) against other trade orders identified with passive order states available in the market at the same or better price.

The matching engine 434 receives an order message 450 from a trading device 410 and may determine whether to allow execution of a trade based on the order parameters of the trade order 452 and the order parameters of one or more of the trade orders 452a to 452n in the order messages 450a to 450n. The matching engine 434 may compare the tradeable object related to the trade order 452 with the tradeable object related to the trade orders 452a to 452n. The matching engine 434 may also compare other order parameters, such as the order price and the order quantity, of the trade order 452 with the order parameters of the trade orders 452a to 452n that are related to the same tradeable object. When the trade order 452 and another trade order are each related to the same tradeable object and include the same trade price for a trade quantity, the matching engine 434 may allow execution of a trade between the trade orders when the order state between the trade orders is determined to be complementary.

The order state 454 may be complementary with any of the order states 454a to 454n when one of the orders is identified as having an aggressive state. As shown in the system 400, the trade order 452 includes an indication that that the order state 454 is a passive order state. The passive order state 454 of trade order 452 may be indicated by setting a value of the order state 454 to T′, or providing another indication of the passive order state. The trade order 452a includes an indication that the order state 454a is an aggressive order state. The aggressive order state 454a of trade order 452a may be indicated by setting a value of the order state 454a to ‘A’, or providing another indication of the aggressive order state.

Upon determining that the trade order 452 is in a passive order state, the matching engine 434 may delay execution of a trade with the trade order 452 until another trade order with a complementary state is received. For example, the matching engine 434 may receive the trade order 452 having the passive order state 454 and the trade order 452a having the aggressive order state 454a. The trade order 452a may include an order for the same tradeable object as the trade order 452. The trade order 452a may have the same trade price as the trade order 452, but may have a trade quantity that is a portion of the trade quantity of the trade order 452, resulting in a partial fill of trade order 452. In certain embodiments, the user of trading device 410 may maintain the passive order state 454 for the trade order 452 upon partial fill of trade order 452. In other embodiments, the user of trading device 410 may configure trade order 452 to change order state 454 to an aggressive order state upon partial fill of trade order 452.

The matching engine 434 may receive the order message 450n having a trade order 452n with an aggressive order state 454n. The trade order 452n may include the same, or better, order price and order quantity as the trade order 452. As the order price and order quantity of the trade order 452n are the same, or better, as the order price and order quantity of the trade order 452, the complementary aggressive order state 454n of the trade order 452n allows for execution of the trade between the trade order 452 and the trade order 452n. The matching engine 434 may determine that the order state 454 and the order state 454n are in a combination of order states that are complementary because they are in the same state and may allow execution of the trade.

In operation, the order state 454 of the trade order 452 may be automatically changed to indicate the aggressive order state or manually changed in response to a user command to in order to indicate the updated order state to the matching engine 434. The order state 454 may be updated by sending another order message with updated parameters that include an updated order state 454. In another example, which may be a more efficient use of network communications, the order state 454 may be sent to the matching engine 434 in an update message independent of one or more of the other parameters in the order message 450. The update message may include the updated order state 454 and an identifier of the trade order 452 and/or the order message 450 to which the updated order state 454 may be applied.

The matching engine 434 may determine that the order state 454 and the order state 454n are in a combination of complementary order states when the order state 454 is a passive order state and the order state 454n is an aggressive order state. Though the order state 454 and the order state 454n are indicated as being different, the matching engine 434 may determine they are complementary when the order parameters would otherwise allow for a match. This way, the trade order 452 and the trade order 452n may be matched without having to perform additional communications or processing to change the trade order 452. For example, the order state 454 may be complementary to the order state 454n when the order price and the order quantity for the trade orders 454 and 452n are a match for a tradeable object and a predetermined period of time has elapsed from receiving the trade order 452 or the trade order 452n.

The matching engine 434 may execute a trade between matched trade orders. The matching engine 434 may store trade orders in the data store 436. For example, the matching engine 434 may store the passive trade order 452 in the data store 436 until the order state 454 is determined to be complementary to another trade order. The matching engine 434 may retrieve the passive trade order 452 from the data store 436 when the order state 454 is determined to be complementary to other trade orders and execute a trade between them.

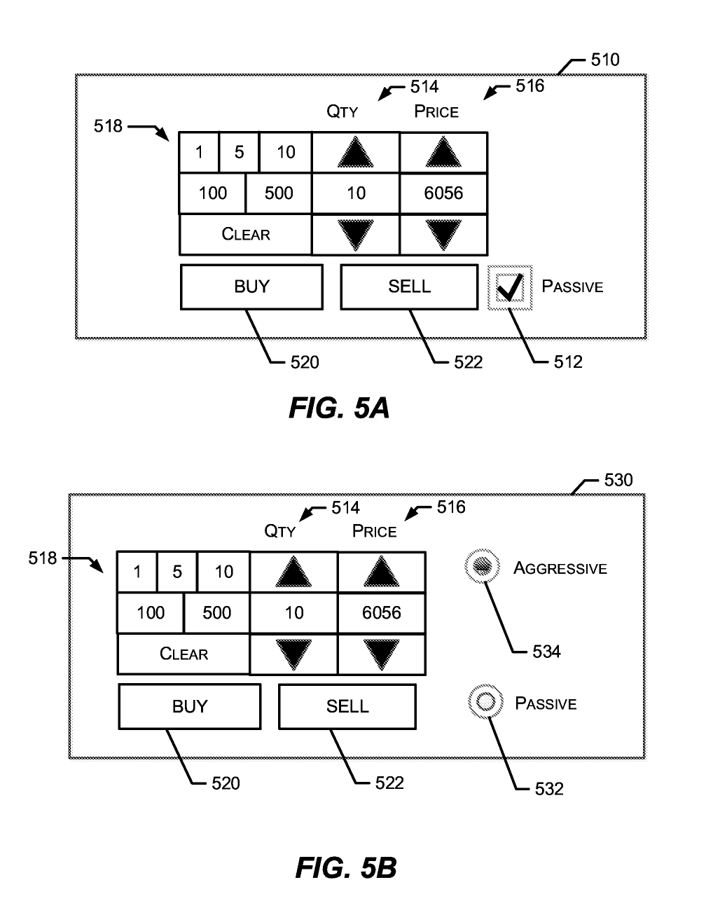

FIG. 5A illustrates an example order window 510 that may be used to receive order parameters for a trade order. The order window 510 may be displayed on a display of a trading device. The order window 510 may allow a user of the trading device to enter one or more order parameters for a trade order. The order window 510 may allow the user to enter an order quantity 514, an order price 516, and/or an order type. The order type may be a buy order that may be indicated by the user selecting the buy button 520 or a sell order that may be indicated by the user selecting the sell order 522. The order window 510 may allow the user to enter predefined order quantities by selecting the predefined quantity buttons 518.

A user may specify an order state as one of the order parameters of a trade order. For example, the user of a trading device may indicate a passive order state for a trade order by using an order state indicator function 512. As shown in the order window 510, the order state indicator function 512 may be a checkbox or similar selection function. The order state indicator function 512 may default to a passive order state or an aggressive order state and may allow the user to change the order state in the order window 510.

A trade order in a passive order state may rest until a complementary aggressive order is received at the matching engine. When the user selects the buy button 520, the sell button 522, or another button for submitting a trade order, an order message may be sent to the matching engine having the order parameters indicated in the order window 510.

FIG. 5B depicts another example order window 520. The order window 520 may include both a passive order state indicator function 532 and an aggressive order state indicator function 534. The passive order state indicator function 532 may be selected to indicate a passive order state. The aggressive order state indicator function 534 may be selected to indicate an aggressive order state. The order state indicator functions 532, 534 may be radio buttons or other functions that allow for selection of the active order state and the passive order state, respectively. The order state indicator functions 532, 534 may default to a passive order state or an aggressive order state and may allow the user to change the order state in the order window 520. When the user selects the buy button 520, the sell button 522, or another button for submitting a trade order, an order message may be sent to the matching engine having the order parameters indicated in the order window 520.

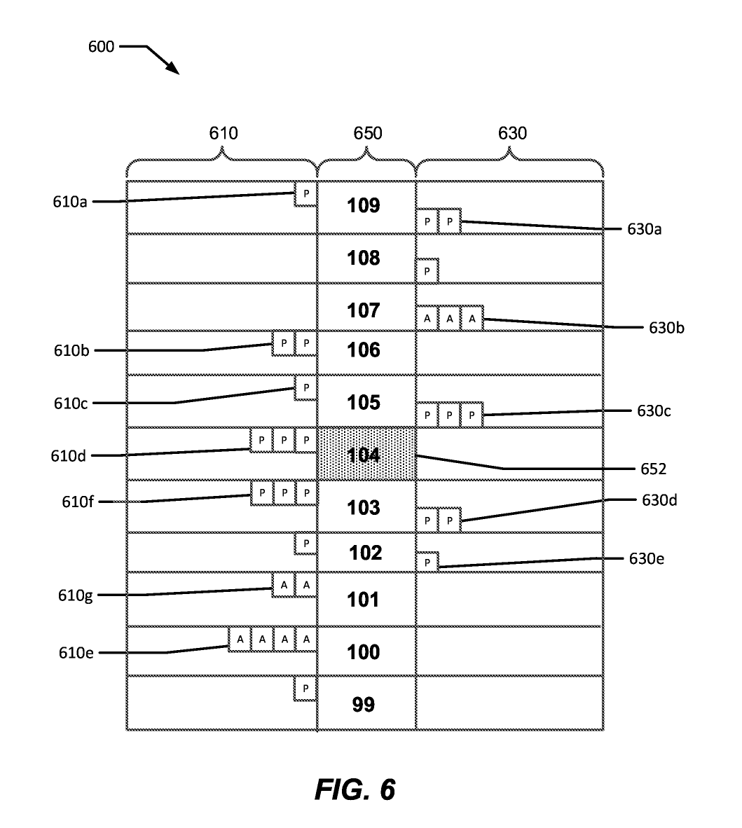

FIG. 6 illustrates an example market window 600 for a tradeable object. The market window 600 may display buy orders 610, sell orders 630, and prices 650 for a number of orders that may be received for a tradeable object at a matching engine. The buy orders 610, sell orders 630, and prices 650 may be received in market data at a trading device for being displayed. For example, the matching engine 434 may communicate information regarding the buy orders 610, sell orders 630, and prices 650 to the trading device. The trading device may display the market window 600 on a display.

The market window 600 may indicate a current price 652. The current price 652 may be the last traded price (LTP) which is the price at which the tradable object was last traded. Buy orders 610 may be resting at prices that are above the current price 652 (e.g., buy orders 610a, 610b, and 610c), at the current price 652 (e.g., buy orders 610d), or below the current price 652 (e.g., buy orders 610e, 610f, and 610g). Sell orders 630 may include sell orders that are above the current price 652 (e.g., sell orders 630a, 630b, and 630c), sell orders that are at the current price 652 (not shown), and/or resting sell orders that are below the current price 652 (e.g., sell orders 630d and 630e).

The market window 600 may indicate that a trade order is in an aggressive or a passive state. For example, trade orders 610b, 610f, 630d, and 630e are identified as being passive orders. Though trade orders 610f and 630d may otherwise include trade parameters that may be matched, the trade orders 610f and 630d may rest and not trade with each other because the order state associated with these order is indicates they are both in a passive order state. In certain embodiments, the order state of the trade orders 610f and 630d may be automatically determined to be complementary, or automatically changed to be complementary, after a period of time or upon submission of the subsequent trade order to facilitate the execution of trades.

Trade orders 610e, 610g, and 630b are identified as including an aggressive order state. In operation, receipt of a contra-side order including either a passive or aggressive order state to any of the trade order 610e, 610g and 630b would result in a fill or partial fill of these complimentary orders.

Trading accounts that are associated with the trading terminals may receive a trade incentive for submitting trade orders that, for example, are placed in the passive order state. The trade incentive may be given to encourage users to submit trade orders that may solicit additional transactions. The trade incentive may be based on the order that is submitted relative to the current price 652. For example, trading accounts that are associated with the trading terminals that generated the buy orders 610a, 610b, and 610c may receive a trade incentive for placing buy orders above the current price 652 in a passive order state. Sell orders 630d and 630e that are below the current price 652 may receive a trade incentive, for example, for providing supply below the current price 652.

The trade incentive may include a credit that may be applied to a trading account of the user. The credit may be used in a future trade, for example to pay the commission of a future trade or to offset exchange order-to-fill ratios. The trade incentive may vary based on the order price and/or the order quantity. For example, the trade incentive for buy order 610a may be higher than the trade incentive for buy order 610b. The trade incentive may increase for each price level above the current price 652.

Buy orders that are at the current price 652 (e.g., buy order 610d) or below the current price 652 (e.g., buy orders 610e, 610f and 610g) may not receive a trade incentive or may receive a lower trade incentive. Sell orders that are at the current price 652 or above the current price 652 (e.g., sell orders 630a, 630b and 630c) may not receive a trade incentive or may receive a lower trade incentive. Alternatively, the incentive determinations may be inverted such that buy orders below the current price or sell orders above the current price may receive the incentives.

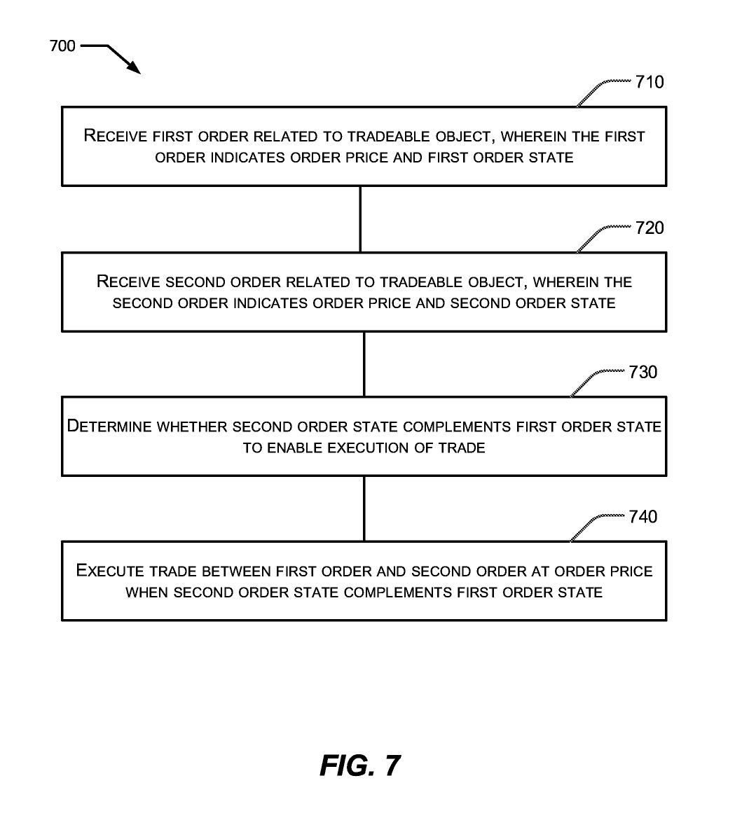

FIG. 7 illustrates a method 700 for executing a trade. One or more portions of the method 700 may be executed by a matching engine. At 710, a trade order may be received. The trade order may relate to a tradable object and may indicate order parameters such as order price, order quantity, or order state. For example, the matching engine may receive the trade order from a trading device and the trade order may include an order state that indicates that the trade order is in an aggressive order state or a passive order state. The trade order being in the passive order state may allow the trade order to be submitted at a higher or lower price value to control the cost associated with a trade. The order parameters in the order received at 710 may also indicate the order quantity.

At 720, another trade order may be received. The trade order received at 720 may relate to the same tradable object as the trade order received at 710. The trade order received at 720 may indicate an order price that may be equal to the order price indicated in the trade order received at 710. The trade order received at 720 may indicate an order quantity that may be greater than or equal to the order price indicated in the trade order received at 710.

The trade order received at 720 may indicate an order state. For example, the order state may include a passive order state or an aggressive order state. At 730, it may be determined whether the order state of a trade order received at 720 complements the order state of the trade order received at 710. For example, the matching engine may determine whether the trade order received at 710 and the trade order received at 720 indicate aggressive order states. At 740, a trade may be executed between the order received at 710 and the order received at 720 when the order states of the two orders are complementary. For example, the matching engine may allow execution of a trade between the trade order received at 710 and the trade order received at 720 when one or both order states indicate an aggressive order state. The order state of the trade order received at 720 may complement the order state of the trade order received at 710 although one of the order states is a passive order state. If the order state of the trade orders received at 710 and 720 are not complementary, the execution of a trade between the two orders may be delayed until the order state of the trade orders received at 710 and 720 are complementary.

An indication of the trade may be sent upon execution of the trade. For example, the matching engine may send a message to the trading devices that submitted the trade orders that are matched in the trade. The message may indicate that the trade between the trade order received at 710 and the trade order received at 720 has been executed. The indication of the trade may be displayed on a trading window of a trading application. The indication may be sent to email addresses associated with the trading device that submitted the trade order at 710 and/or the trading device that submitted the trade order at 720.

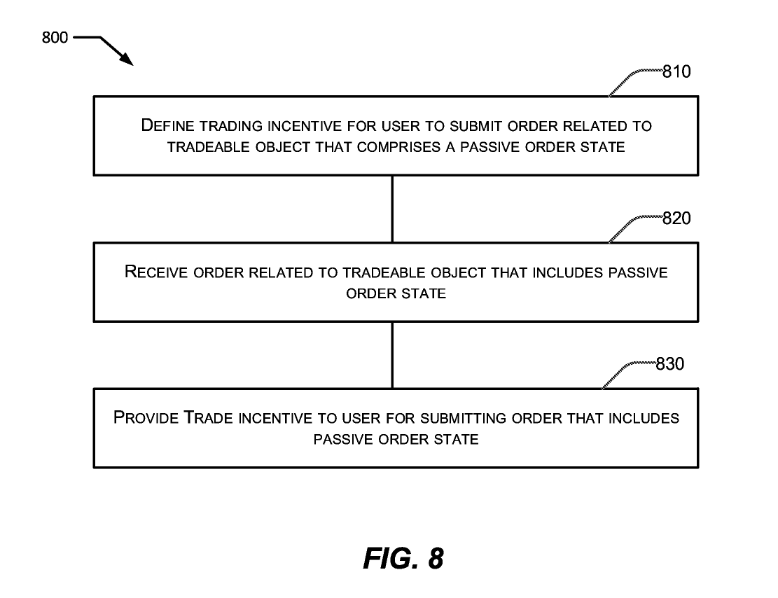

FIG. 8 illustrates a method 800 for providing a trade incentive to a trade order submitted in a held order state. The trade incentive may be used to encourage a trade order to be submitted in a passive order state and promote the execution of transactions at an electronic exchange. At 810, a trade incentive may be defined for encouraging a trade order to be submitted. The trade incentive may include a credit to a user account that may be applied to future trades or fees associated with future trades. The trade incentive may include a discount in transaction fees associated with submitting a current or future trade order (e.g., 50% discount on trading fees for the next three trades). The trade incentive may be applied in the form of a single transaction fee debited from a user account when multiple transactions are performed to meet the trade quantity of a trade order having a passive order state.

The trade incentive may be defined by a matching engine and/or a trading device. A trade incentive may be defined for buy orders that indicate a passive order state and a buy price that is above the current market price. A trade incentive may be defined for sell orders that indicate a passive order state and an ask price that is below the current market price. A trade incentive may be defined to provide buying and selling opportunities at prices that are different from the current market price.

The trade incentive may be a function of a difference between an order price and the market price. For example, a larger trade incentive may be provided when the difference between the order price and the market price is greater than a threshold and a smaller trade incentive may be provided when the difference between the order price and the market price is below the threshold.

Referring again to FIG. 8, a trade order may be received at 820 that includes an order parameter that indicates a passive order state. For example, the trade order may indicate that the trade order has a passive order state. The trade order may include an order price that may be different from the current market price. An amount of the trade incentive may be determined based on the order price and/or the order quantity. For example, a one tick credit may be provided for buy orders that are 10% better than the current market price and a two tick credit may be provided for buy orders that are 20% better than the current market price.

At 830, the trade incentive may be provided to the user for submitting the trade order that includes the passive order state. A portion of the trade incentive may be provided upon receiving the trade and the remainder of the trade incentive may be provided upon execution of the trade. In another example, the entire trade incentive may be provided upon execution of the trade.

After the trade is executed between two trade orders having complementary order states, a message may be sent to the trading terminals that generated the orders. The message may indicate that a trade has been executed. The message may indicate the trade incentive that the user received as a result of a trade. The message may indicate an amount of the trade incentive.

Some of the described figures depict example block diagrams, systems, and/or flow diagrams representative of methods that may be used to implement all or part of certain embodiments. One or more of the components, elements, blocks, and/or functionality of the example block diagrams, systems, and/or flow diagrams may be implemented alone or in combination in hardware, firmware, discrete logic, as a set of computer readable instructions stored on a tangible computer readable medium, and/or any combinations thereof, for example.

The example block diagrams, systems, and/or flow diagrams may be implemented using any combination of application specific integrated circuit(s) (ASIC(s)), programmable logic device(s) (PLD(s)), field programmable logic device(s) (FPLD(s)), discrete logic, hardware, and/or firmware, for example. Also, some or all of the example methods may be implemented manually or in combination with the foregoing techniques, for example.

The example block diagrams, systems, and/or flow diagrams may be performed using one or more processors, controllers, and/or other processing devices, for example. For example, the examples may be implemented using coded instructions, for example, computer readable instructions, stored on a tangible computer readable medium. A tangible computer readable medium may include various types of volatile and non-volatile storage media, including, for example, random access memory (RAM), read-only memory (ROM), programmable read-only memory (PROM), electrically programmable read-only memory (EPROM), electrically erasable read-only memory (EEPROM), flash memory, a hard disk drive, optical media, magnetic tape, a file server, any other tangible data storage device, or any combination thereof. The tangible computer readable medium is non-transitory.

Further, although the example block diagrams, systems, and/or flow diagrams are described above with reference to the figures, other implementations may be employed. For example, the order of execution of the components, elements, blocks, and/or functionality may be changed and/or some of the components, elements, blocks, and/or functionality described may be changed, eliminated, sub-divided, or combined. Additionally, any or all of the components, elements, blocks, and/or functionality may be performed sequentially and/or in parallel by, for example, separate processing threads, processors, devices, discrete logic, and/or circuits.

While embodiments have been disclosed, various changes may be made and equivalents may be substituted. In addition, many modifications may be made to adapt a particular situation or material. Therefore, it is intended that the disclosed technology not be limited to the particular embodiments disclosed, but will include all embodiments falling within the scope of the appended claims.

What is claimed is:

1. A method comprising:
receiving, from a first computing device, a first order related to a tradeable object, wherein the first order indicates an order price and a first order state;
receiving, from a second computing device, a second order related to the tradeable object, wherein the second order indicates the order price and a second order state;
determining whether the second order state complements the first order state in a combination of states that enables execution of a trade of the tradeable object; and
when the second order state complements the first order state, executing the trade between the first order and the second order at the order price.

2. The method of claim 1, wherein the second order state complements the first order state when the second order state matches the first order state.

3. The method of claim 1, wherein the first order state indicates a passive order.

4. The method of claim 3, wherein the second order state includes an aggressive order state indicating an instruction to use the second order to execute the trade.

5. The method of claim 1, further comprising:
defining a first trade incentive for the first order state; and
crediting a first trading account associated with the first computing device when the trade is executed between the first order and the second order.

6. The method of claim 5, further comprising:
defining a second trade incentive for the second order state; and
crediting a second trading account associated with the second computing device when the trade is executed between the first order and the second order.

7. The method of claim 6, wherein the first trade incentive is greater than the second trade incentive.

8. The method of claim 1, further comprising:
sending an indication of the first order to the second computing device; and
indicating, to the second computing device, that the first order is associated with the first order state.

9. The method of claim 1, further comprising:
sending an indication of the second order to the first computing device;
indicating, to the first computing device, that the second order is associated with the second order state that complements the first order state; and
receiving an instruction from the first computing device to execute the trade between the first order and the second order.

10. The method of claim 1, further comprising communicating to the first computing device and the second computing device that the trade between the first order and the second order has been executed.

11. The method of claim 1, wherein the method is performed by a matching engine located at an electronic exchange.

12. The method of claim 1, wherein the first order and the second order are received via a communication interface located at a third computing device, and wherein the determining whether the second order state complements the first order state is performed by a processor located at the third computing device.

13. The method of claim 12, wherein the third computing device is one of a trading device or an electronic exchange.

14. The method of claim 1, wherein the first computing device and the second computing device are trading terminals.

15. A method comprising:
defining a trade incentive, wherein the trade incentive is associated with a passive order state configured to control execution of an order;
receiving, from a first computing device, a first order related to a tradeable object, wherein the first order indicates an order price, an order quantity, and a first order state includes the passive order state;
providing the trade incentive to a user of the first computing device;
displaying the first order in a trading window at a price level that is based on the order price;
displaying an indication that the first order is in the passive order state;
receiving, from a second computing device, a second order related to the tradeable object, wherein the second order indicates the order price, at least a portion of the order quantity, and a second order state includes an aggressive order state, wherein the aggressive order state enables the second order to be executed in the trade with the first order when the first order state comprises the aggressive order state;
displaying the second order in the trading window at the price level that is based on the order price;
displaying an indication that the second order is in the aggressive order state;
executing, based on the first order state and the second order state, the trade between the first order and the second order at the order price; and
sending a message to the first computing device and the second computing device, wherein the message indicates the trade executed between the first order and the second order.

16. The method of claim 15, wherein the trade incentive comprises a credit for a future trade.

17. The method of claim 15, wherein the method is performed by a matching engine residing in at least one of a trading device or an electronic exchange.

18. The method of claim 15, wherein the first order and the second order are received via a communication interface located at a third computing device, and wherein the trade is executed between the first order and the second order by a processor located at the third computing device.

19. The method of claim 15, wherein the first computing device and the second computing device are trading terminals.
